(19) United States
(12) Patent Application Publication
(10) Pub. No.: US 2012/0004325 A1
(43) Pub. Date: Jan. 5, 2012

(54) Insecticidal or acaricidal formulations with improved availability on plant surfaces

(75) Inventors: Heike Hungenberg, Langenfeld (DE); Karl-Josef Haack, Langenfeld (DE); Johan Kijlstra, Odenthal (DE); Elias Tapia Ramos, Dusseldorf (DE); Kai Wirtz, Dusseldorf (DE); Volker Gutsmann, Langenfeld (DE)

(73) Assignee: Bayer CropScience AG, Monheim am Rhein (DE)

(21) Appl. No.: 13/176,066

(22) Filed: Jul. 5, 2011

Related U.S. Application Data
(60) Provisional application No. 61/361,018, filed on Jul. 2, 2010.

(30) Foreign Application Priority Data
Jul. 2, 2010 (EP) 10168204.5

(51) Int. Cl. A01N 25/02; A01P 7/02; A01P 15/00

(52) U.S. Cl. 514/785; 514/788

(57) ABSTRACT

The invention relates to the use of compositions comprising at least one insecticide or acaricide, at least one nonionic and/or one ionic dispersant and an aqueous polymer dispersion for improving the availability of the insecticide or acaricide on plant surfaces.

The present invention relates to the use of compositions for pest control, more particularly to insecticidal or acaricidal suspension concentrates and to spray solutions prepared from them, to a process for preparing them, and to the use of such formulations for the sustained control of animal pests (arthropods) on plant surfaces. The present invention relates more particularly to the use of certain polymer dispersions in pest control compositions in order to improve the availability of the insecticide or acaricide on the treated plants and at the same time to protect the crop protection agent from environmental effects and thereby to improve the long-term activity of these compositions, their bioavailability and their stability to rain and to UV.

WO-A-2009/141109 discloses compositions comprising
at least one insecticide or acaricide,
a nonionic and/or an ionic dispersant,
an aqueous polymer dispersion,
   the polymer dispersion in one embodiment being prepared, for example, by polymerization in the presence of a hydrocolloid as graft base.

Likewise, the subject matter of WO-A-2009/141109 are compositions comprising
at least one insecticide or acaricide,
a nonionic and/or an ionic dispersant,
an aqueous polymer dispersion,
   the aqueous polymer dispersion being in one embodiment, for example, a cationic polymer dispersion which comprises an emulsifier which as a structural component has at least one (meth)acrylic ester and/or (meth)acrylamide, which contains a tertiary amino group.

WO-A-2009/141109 discloses the application of these compositions to industrial materials, but not to plants. WO-A-2009/141109 further discloses the heavy dependency of the efficacy of such an application on the nature of the spray surface.

Also known are common formulations of active insecticidal or acaricidal ingredients, as for example of deltamethrin (commercial product DECIS Expert®), which are applied to leaf surfaces. These formulations, in addition to the active insecticidal or acaricidal ingredient, comprise further formulating auxiliaries, but not aqueous polymer dispersions.

These commercial products have a broad spectrum of activity with a good level of action, but are not always available ideally for the particular pests and exhibit poor control of the target pest under certain environmental influences, such as UV radiation, fluctuating temperatures and rain. One of the reasons for this poor control is thought to be the insufficiently long availability of the active ingredients on the leaf surfaces.

It was an object of the present application therefore to improve the availability of the insecticides or acaricides on plant surfaces and to prolong the residual activity, in addition to improved UV protection and rain-resistance. Through the use of an optimized formulation of this kind, the number of applications can be reduced and hence the total amount of crop protection agents delivered can be lessened.

The invention relates to the use of a composition comprising
at least one insecticide or acaricide
at least one nonionic and/or one ionic dispersant
an aqueous polymer dispersion
   for improving the availability of the insecticide or acaricide on plant surfaces.

It has surprisingly been found that when the compositions described are used, the plants treated therewith are protected longer and more effectively from pest infestation than when using corresponding prior-art compositions which do not contain the aqueous polymer dispersions. This is the case more particularly under the influence of fluctuating temperatures, rain and UV irradiation. The compositions used in accordance with the invention therefore result in improved availability of the insecticide or acaricide and, in tandem therewith, enhanced pest control on the treated plants.

One preferred embodiment of the invention uses an aqueous polymer dispersion which is prepared by polymerization in the presence of a hydrocolloid as graft base.

It has also surprisingly been found that the compositions used in accordance with the invention have proved to be advantageous in application. For instance, the clogging of nozzles in the equipment utilized for spraying is less frequent than with existing formulations.

On account of the water-solubility of the formulations used in accordance with the invention, the equipment utilized for their application is particularly easy to clean, even after residues of product have dried off.

The compositions used in accordance with the invention preferably comprise:
at least one insecticide and/or acaricide selected from pyrethroids, pyrazoles, neonicotinoids, diamides (anthranilamides, benzenedicarboxamides), enaminocarbonyl compounds, carbamates, fermentation products, ketoenols and botanical and inorganic insecticides.

Those used in accordance with the invention comprise with particular preference:
at least one insecticide and/or acaricide selected from beta-cyfluthrin, cyfluthrin, cypermethrin, alpha-cypermethrin, deltamethrin, bifenthrin, flumethrin, permethrin, lambda-cyhalothrin, gamma-cyhalothrin, metofluthrin, etofenprox, transfluthrin, pyrethrum, indoxacarb, carbaryl, ethiprole, metaflumizone, flonicamid, azadirachtin, flubendiamide, chlorantraniliprole, cyazypyr, flonicamid, sulfoxaflor, 4-{[6-chloropyrid-3-yl)methyl](2,2-difluoroethyl)amino}furan-2(5H)-one, imidacloprid, clothianidin, thiacloprid, thiamethoxam, nitenpyram, dinotefuran and acetamiprid, chlorfenapyr, chlorpyrifos, thiodicarb, triflumuron, spinosad and spinetoram, spirotetramat, spirodiclofen and spiromesifen, abamectin and emamectin benzoate.

The active ingredients identified here by their “common name” are known and are described in, for example, a pesticide handbook (“The Pesticide Manual” 14th ed., British Crop Protection Council 2006) or can be looked up on the Internet (e.g. http://www.alanwood.net/pesticides).

In addition to the above-recited insecticides and/or acaricides, compositions used in accordance with the invention may comprise further active insecticidal or acaricidal ingredients, selected, for example, from the following:

(1) Acetylcholinesterase (AChE) inhibitors, such as, for example,

carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, for example acephate, azamethiphos, azinphos (-methyl, -ethyl), cadusafos, chlorethoxyfos, chlorfenvinphos, chlormephos, chlorpyrifos (-methyl), coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion (-methyl), phenthoate, phorate, phosalone, phosmet, phosphamidon, phoxim, pirimiphos (-methyl), profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel antagonists, such as, for example,

organochlorines, for example chlordane and endosulfan (alpha-); or
fiproles (phenylpyrazoles), for example ethiprole, fipronil, pyrafluprole and pyriprole.

(3) Sodium channel modulators/voltage-dependent sodium channel blockers, such as, for example,

pyrethroids, for example acrinathrin, allethrin (d-cis-trans, d-trans), bifenthrin, bioallethrin, bioallethrin-S-cyclopentenyl, bioresmethrin, cycloprothrin, cyfluthrin (beta-), cyhalothrin (gamma-, lambda-), cypermethrin (alpha-, beta-, theta-, zeta-), cyphenothrin [(1R)-trans-isomers], deltamethrin, dimefluthrin, empenthrin [(EZ)-(1R)-isomers], esfenvalerate, etofenprox, fenpropathrin, fenvalerate, flucythrinate, flumethrin, fluvalinate (tau-), halfenprox, imiprothrin, metofluthrin, permethrin, phenothrin [(1R)-trans-isomer], prallethrin, profluthrin, pyrethrins (pyrethrum), resmethrin, RU 15525, silafluofen, tefluthrin, tetramethrin [(1R)-isomers], tralomethrin, transfluthrin and ZXI 8901; or
DDT; or methoxychlor.

(4) Nicotinergic acetylcholine receptor agonists, such as, for example,

neonicotinoids, for example acetamiprid, clothianidin, dinotefuran, imidacloprid, nitenpyram, thiacloprid, thiamethoxam; or
nicotine.

(5) Allosteric acetylcholine receptor modulators (agonists), such as, for example,

spinosyns, for example spinetoram and spinosad.

(6) Chloride channel activators, such as, for example,

avermectins/milbemycins, for example abamectin, emamectin benzoate, lepimectin and milbemectin.

(7) Juvenile hormone analogues, for example hydroprene, kinoprene, methoprene; or fenoxycarb; pyriproxyfen.

(8) Active ingredients with unknown or non-specific mechanisms of action, such as, for example,

fumigants, for example methyl bromide and other alkyl halides; or
chloropicrin; sulphuryl fluoride; borax; tartar emetic.

(9) Selective antifeedants, for example pymetrozine; or flonicamid.

(10) Mite growth inhibitors, for example clofentezine, diflovidazin, hexythiazox, etoxazole.

(11) Microbial disruptors of the insect gut membrane, such as, for example, Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins, for example Cry1Ab, Cry1Ac, Cry1Fa, Cry2Ab, mCry3A, Cry3Ab, Cry3Bb, Cry34/35Ab1.

(12) Oxidative phosphorylation inhibitors, ATP disruptors, such as, for example, diafenthiuron; or

organotin compounds, for example azocyclotin, cyhexatin, fenbutatin oxide; or
propargite; tetradifon.

(13) Oxidative phosphorylation decouplers acting by interrupting the H proton gradient, such as, for example, chlorfenapyr and DNOC.

(14) Nicotinergic acetylcholine receptor antagonists, such as, for example, bensultap, cartap (hydrochloride), thiocylam, and thiosultap (sodium).

(15) Chitin biosynthesis inhibitors, type 0, such as, for example, benzoylureas, for example bistrifluron, chlorfluazuron, diflubenzuron, flucycloxuron, flufenoxuron, hexaflumuron, lufenuron, novaluron, noviflumuron, teflubenzuron and triflumuron.

(16) Chitin biosynthesis inhibitors, type 1, such as, for example, buprofezin.

(17) Moulting disruptors, such as, for example, cyromazine.

(18) Ecdysone agonists/disruptors, such as, for example,

diacylhydrazines, for example chromafenozide, halofenozide, methoxyfenozide and tebufenozide.

(19) Octopaminergic agonists, such as, for example, amitraz.

(20) Complex-III electron transport inhibitors, such as, for example, hydramethylnon; acequinocyl; fluacrypyrim.

(21) Complex-I electron transport inhibitors, for example from the group of the METI acaricides, for example fenazaquin, fenpyroximate, pyrimidifen, pyridaben, tebufenpyrad, tolfenpyrad; or

rotenone (derris).

(22) Voltage-dependent sodium channel blockers, for example indoxacarb; metaflumizone.

(23) Inhibitors of acetyl-CoA carboxylase, such as, for example, tetronic acid derivatives, for example spirodiclofen and spiromesifen; or tetramic acid derivatives, for example spirotetramat.

(24) Complex-IV electron transport inhibitors, such as, for example, phosphines, for example aluminium phosphide, calcium phosphide, phosphine, zinc phosphide; or cyanide.

(25) Complex-II electron transport inhibitors, such as, for example, cyenopyrafen.

(28) Ryanodine receptor effectors, such as, for example, diamides, for example flubendiamide, chlorantraniliprole (Rynaxypyr), cyantraniliprole (Cyazypyr) and also 3-bromo-N-{2-bromo-4-chloro-6-[(1-cyclopropylethyl)carbamoyl]phenyl}-1-(3-chloropyridin-2-yl)-1H-pyrazole-5-carboxamide (known from WO2005/077934) or methyl 2-[3,5-dibromo-2-({[3-bromo-1-(3-chloropyridin-2-yl)-1H-pyrazol-5-yl]carbonyl}amino)benzoyl]-1,2-dimethylhydrazinecarboxylate (known from WO2007/043677).

Further active ingredients with unknown mechanism of action, such as, for example, azadirachtin, amidoflumet, benzoximate, bifenazate, chinomethionat, cryolite, cyflumetofen, dicofol, fluensulfone (5-chloro-2-[(3,4,4-trifluorobut-3-en-1-yl)sulphonyl]-1,3-thiazole), flufenerim, pyridalyl and pyrifluquinazon; and also products based on Bacillus firmus (I-1582, BioNeem, Votivo) and also the known active compounds below

4-{[(6-bromopyrid-3-yl)methyl](2-fluoroethyl)amino}furan-2(5H)-one (known from WO 2007/115644), 4-{[(6-fluoropyrid-3-yl)methyl](2,2-difluoroethyl)amino}furan-2(5H)-one (known from WO 2007/115644), 4-{[(2-chloro-1,3-thiazol-5-yl)methyl](2-fluoroethyl)amino}furan-2(5H)-one (known from WO 2007/115644), 4-{[(6-chloropyrid-3-yl)methyl](2-fluoroethyl)amino}furan-2(5H)-one (known from WO 2007/115644), 4-{[(6-chloropyrid-3-yl)methyl](2,2-difluoroethyl)amino}furan-2(5H)-one (known from WO 2007/115644), 4-{[(6-chloro-5-fluoropyrid-3-yl)methyl](methyl)amino}furan-2(5H)-one (known from WO 2007/115643), 4-{[(5,6-dichloropyrid-3-yl)methyl](2-fluoroethyl)amino}furan-2(5H)-one (known from WO 2007/115646), 4-{[(6-chloro-5-fluoropyrid-3-yl)methyl](cyclopropyl)amino}furan-2(5H)-one (known from WO 2007/115643), 4-{[(6-chloropyrid-3-yl)methyl](cyclopropyl)amino}furan-2(5H)-one (known from EP-A-0 539 588), 4-{[(6-chloropyrid-3-yl)methyl](methyl)amino}furan-2(5H)-one (known from EP-A-0 539 588), [(6-chloropyridin-3-yl)methyl](methyl)oxido-λ⁴-sulphanylidenecyanamide (known from WO 2007/149134), [1-(6-chloropyridin-3-yl)ethyl](methyl)oxido-λ⁴-sulphanylidenecyanamide (known from WO 2007/149134) and its diastereomers (A) and (B)

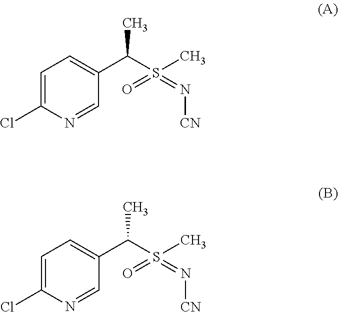

(also known from WO 2007/149134), [(6-trifluoromethylpyridin-3-yl)methyl](methyl)oxido-λ⁴-sulphanylidenecyanamide (known from WO 2007/095229), sulfoxaflor
(also known from WO 2007/149134), 11-(4-chloro-2,6-dimethylphenyl)-12-hydroxy-1,4-dioxa-9-azadispiro[4.2.4.2]tetradec-11-en-10-one (known from WO 2006/089633), 3-(4′-fluoro-2,4-dimethylbiphenyl-3-yl)-4-hydroxy-8-oxa-1-azaspiro[4.5]dec-3-en-2-one (known from WO 2008/067911),
1-[2-fluoro-4-methyl-5-[(2,2,2-trifluoroethyl)sulphinyl]phenyl]-3-(trifluoromethyl)-1H-1,2,4-triazole-5-amine (known from WO 2006/043635),
[(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methyl cyclopropanecarboxylate (known from WO 2006/129714),
2-cyano-3-(difluoromethoxy)-N,N-dimethylbenzene sulphonamide (known from WO2006/056433),
2-cyano-3-(difluoromethoxy)-N-methylbenzene sulphonamide (known from WO2006/100288), 2-cyano-3-(difluoromethoxy)-N-ethylbenzenesulphonamide (known from WO2005/035486), 4-(difluoromethoxy)-N-ethyl-N-methyl-1,2-benzothiazole-3-amine 1,1-dioxide (known from WO2007/057407) and
N-[1-(2,3-dimethylphenyl)-2-(3,5-dimethylphenyl)ethyl]-4,5-dihydro-1,3-thiazole-2-amine (known from WO2008/104503).

Preference is given to compositions used in accordance with the invention with more than one active insecticidal or acaricidal ingredient, the at least two different active insecticidal or acaricidal ingredients being preferably selected from the group consisting of the following:

imidacloprid, thiacloprid, 4-{[6-chloropyrid-3-yl)methyl](2,2-difluoroethyl)amino}furan-2(5H)-one, sulfoxaflor, spinetoram, abamectin, ethiprole, fipronil, flubendiamide, rynaxypyr, cyazypyr, spirotetramat, spirodiclofen, spiromesifen, flonicamid, indoxacarb, metaflumizone.

The compositions used in accordance with the invention comprise preferably an aqueous anionic, cationic or amphoteric polymer dispersion.

Suitable polymer dispersions are preferably polymer dispersions which, at a concentration of 0.025% by weight based on the solids content in demineralized water, have an absorbance, measured in a 1 cm cell at 535 nm, of less than 2.0, preferably less than 1.0 and especially preferably less than 0.1. These polymer dispersions preferably have fine particulately dispersed particles of solid.

Preferably used polymer dispersions are those which, after drying, have a glass transition temperature of from 0° C. to 120° C., preferably from 25° C. to 90° C. and especially preferably from 40° C. to 80° C.

The glass transition temperature of the polymers is determined as follows: polymer dispersion which has been left to dry in a DSC pan (drying for 24 hours at room temperature and 0% relative humidity) is determined using the Perkin-Elmer DSC-7 differential scanning calorimeter, equipped with intracooler, over three heating/cooling cycles (−100° C. to +150° C., heating rate 20 K/min, cooling rate 320 K/min, nitrogen flushing with a gas flow rate of 30 ml/min). The glass transition temperature was evaluated at half the level of the glass transition.

The minimum film-formation temperature (MFT) is determined using the Thermostair® temperature gradient testing apparatus (Coesfeld Messtechnik GmbH) as specified in DIN ISO 2115.

To determine the stability to electrolytes of the polymer dispersions, the absorbance measurement is carried out as above in parallel after dilution in water and in a CaCl₂ dispersion (50 mM). The measurement is carried out 24 hours after preparing the dilution. The relative difference of the two absorbance values (water to CaCl₂ solution) is a measure of the stability to electrolytes. Polymer dispersions with good stability to electrolytes have a relative absorbance difference of less than 20%, preferably less than 5% and especially preferably less than 3%.

Preferably used polymer dispersions are those which are obtainable by polymerization of a monomer mixture comprising one or more compounds selected from styrene, substituted styrene, acrylonitrile, methacrylonitrile, acrylic esters and (meth)acrylamides.

Examples of acrylic esters which can be employed are methyl acrylate, methyl methacrylate, ethyl acrylate, ethyl methacrylate, propyl acrylate, propyl methacrylate, n-butyl acrylate, isobutyl acrylate, tert-butyl acrylate, n-butyl methacrylate, isobutyl methacrylate, tert-butyl methacrylate, hexyl acrylate, hexyl methacrylate, ethylhexyl acrylate, stearyl acrylate and stearyl methacrylate. Mixtures of isomeric butyl acrylates are preferred.

Particularly preferably used are polymer dispersions which are obtainable by polymerization of a monomer mixture comprising an optionally substituted styrene and a C₁-C₄-alkyl ester of (meth)acrylic acid.

Substituted styrenes which are preferably employed are α-methylstyrene, vinyltoluene or a mixture of these.

Preferably used cationic, aqueous polymer dispersions are obtainable for example by polymerization of a monomer mixture consisting of
a) 20-60% by weight of at least one optionally substituted styrene,
b) 40-80% by weight of at least one C₁-C₁₈ ester of (meth)acrylic acid and
c) 0-20% by weight of at least one nonionic ethylenically unsaturated monomer other than a) and b),
   with the total of a)+b)+c) being 100% by weight,
   in the presence of an aqueous polymer dispersion obtainable by a solution polymerization, carried out in a saturated C₁-C₆ carboxylic acid, of a monomer mixture consisting of
d) 15-35% by weight of at least one (meth)acrylic ester and/or (meth)acrylamide which contains a tertiary amino group,
e) 65-85% by weight of at least one optionally substituted styrene and
f) 0-20% by weight of at least one nonionic or cationic ethylenically unsaturated monomer other than d) and e),
   with the total of d)+e)+f) being 100% by weight.

The cationic polymer dispersion is prepared by emulsion polymerization of a monomer mixture a) to c) in the presence of an aqueous polymer dispersion which acts as emulsifier. The emulsifier, in turn, is obtained by solution polymerization of the monomer mixture d) to f), which is carried out in a saturated C₁-C₆ carboxylic acid, and, if appropriate, is treated with water after intermediate isolation and/or work-up.

To prepare the emulsifier, it is preferred to employ, as monomers of group d), (meth)acrylic esters or (meth)acrylamides of the formula (I)

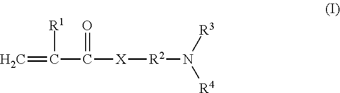

in which
R¹ represents H or methyl,
R² represents a linear C₁-C₄-alkylene radical,
R³ and R⁴ are identical or different and represent C₁-C₄-alkyl and
X represents O or NH.

The monomers of group d) which are employed in particular are compounds which correspond to the formula (I), where R³ and R⁴ are identical and represent methyl or ethyl. Monomers of group d) which are especially preferably employed are compounds of the formula (I) where X represents NH and R³ and R⁴ are identical and represent methyl or ethyl. Monomers of group d) which are very especially preferably employed are those which correspond to the formula (I) where R¹ represents H or methyl, R² represents n-propyl, R³ and R⁴ are identical and represent methyl and X represents NH.

To prepare the emulsifier, at least one styrene which may optionally be substituted is employed as monomer of group e). From the series of the substituted styrenes, it is preferred to employ α-methylstyrene or vinyltoluene. Unsubstituted styrene is especially preferably employed.

To prepare the emulsifier, the monomers of group f) which are employed are nonionic or cationic, ethylenically unsaturated monomers which are different from d) and e). It is preferred to employ nitriles such as, for example, acrylonitrile or methacrylonitrile, amides such as, for example, acrylamide, methacrylamide or N-methylolacrylamide, vinyl compounds such as, for example, vinyl acetate or vinyl propionate, acrylic or methacrylic esters of alcohols having 1-18 C atoms such as, for example, methyl acrylate, methyl methacrylate, ethyl acrylate, ethyl methacrylate, propyl acrylate, propyl methacrylate, n-, iso- and tert-butyl acrylate, n-, iso- and tert-butyl methacrylate, hexyl acrylate, hexyl methacrylate, ethylhexyl acrylate, stearyl acrylate and stearyl methacrylate or esters of acrylic acid or methacrylic acid which have been prepared by reaction with at least one ethylene oxide unit, such as, for example, hydroxyethyl methacrylate or diethylene glycol monomethacrylate. It is especially preferred to employ, as cationic monomers of group f), vinylpyridine or the quaternized ammonium salts derived from the formula (I), which can be obtained for example by reacting compounds of the formula (I) with customary quaternization reagents such as, for example, methyl chloride, benzyl chloride, dimethyl sulphate or epichlorohydrin, such as, for example, 2-(acryloyloxy)ethyltrimethylammonium chloride, 2-(methacryloyloxy)ethyltrimethylammonium chloride, 3-(acrylamido)propyltrimethylammonium chloride or 3-(methylacrylamido)propyltrimethyl-ammonium chloride.

The parts by weight of the monomers identified under d) to f) refer to the total amount of the monomers employed for the preparation of the emulsifier, the total of d)+e)+f) amounting to 100% by weight. It is preferred to employ 20 to 30% by weight of d), 70 to 80% by weight of e) and 0 to 10% by weight of f).

The solution polymerization which is carried out for preparing the emulsifier is carried out as a free-radical polymerization in a saturated C₁-C₆ carboxylic acid as the solvent. In this context, it is possible to employ not only saturated C₁-C₆ monocarboxylic acids, but also saturated C₁-C₆ dicarboxylic acids; it is preferred to employ saturated C₁-C₆ monocarboxylic acids. The saturated C₁-C₆ carboxylic acids which are employed optionally have attached to them further substituents such as, for example, hydroxyl groups. The solution polymerization is preferably carried out in formic acid, acetic acid, propionic acid, butyric acid, isobutyric acid, valeric acid, isovaleric acid, caproic acid, hydroxypropionic acid or hydroxybutyric acid. Mixtures of a variety of saturated C₁-C₆ carboxylic acids can also be employed. It is preferred to carry out the solution polymerization in formic acid, acetic acid, propionic acid or hydroxypropionic acid, especially preferably in acetic acid. In this context, the saturated C₁-C₆ carboxylic acid employed preferably contains no more than 20% by weight of water, especially preferably no more than 10% by weight of water, very especially preferably no more than 1% by weight of water, based on the total amount of solvent. It is very especially preferred to carry out the solution polymerization in at least 99% strength acetic acid without the admixture of other carboxylic acids. The amount of solvent is chosen such that the concentration of the resulting emulsifier solution is 20 to 70% by weight, calculated from the amount of monomers employed.

The solution polymerization is preferably carried out in the presence of a polymerization regulator. Suitable polymerization regulators are, mainly, sulphur compounds such as, for example, thioglycolic acid or mercaptans such as, for example, ethyl mercaptan, n-butyl mercaptan, tert-butyl mercaptan, n-dodecyl mercaptan or tert-dodecyl mercaptan. It is preferred to employ mercaptans, especially preferably C₈-C₁₄ alkyl mercaptans.

The solution polymerization is initiated by a free-radical initiator. Free-radical initiators for the solution polymerization which are preferably employed are peroxo or azo compounds such as, for example, hydrogen peroxide, sodium peroxodisulphate, potassium peroxodisulphate and ammonium peroxodisulphate, di-tert-butyl peroxide, dibenzoyl peroxide, azobisisobutyronitrile, 2,2′-azobis(2-methylbutyronitrile), 2,2′-azobis(2,4-dimethylvaleronitrile) or 2,2′-azobis(2-amidinopropane)dihydrochloride. It is preferred to employ azo compounds, especially preferably nitriles such as, for example, azobisisobutyronitrile, 2,2′-azobis(2-methylbutyronitrile) or 2,2′-azobis(2,4-dimethylvaleronitrile).

When carrying out the solution polymerization, the amount of free-radical initiator and polymerization regulator is chosen such that an emulsifier with a mass-average molar weight of from 5000 to 100 000 g/mol is obtained. The determination of the molar weight distribution and of the mass-average molar weight can be carried out by methods known to the skilled worker such as, for example, gel permeation chromatography, light scattering or ultracentrifugation.

After the solution polymerization has ended, the emulsifier obtained is either subjected to intermediate isolation or directly treated with water. It is preferred to treat the emulsifier obtained directly with water and to prepare, by stirring, a homogeneous liquid phase in which the emulsifier is present in partially dissolved and partially dispersed form. The concentration of the emulsifier in the liquid phase after the addition of water is preferably 2 to 20% by weight, especially preferably 5 to 15% by weight. This liquid phase can be employed directly as an initial charge for carrying out the emulsion polymerization for the preparation of the cationic finely-divided aqueous polymer dispersion.

The cationic aqueous polymer dispersion is prepared by emulsion polymerization of a monomer mixture consisting of a) to c), where the aqueous polymer dispersion prepared in the first step acts as the emulsifier.

To prepare the cationic aqueous polymer dispersion, the monomers of group a) which are employed are styrene and/or substituted styrenes such as, for example, α-methylstyrene or vinyltoluene. It is especially preferred to employ unsubstituted styrene.

To prepare the cationic aqueous polymer dispersion, the monomers of group b) which are employed are at least one C₁-C₁₈ ester of (meth)acrylic acid. It is preferred to employ methacrylate, methyl methacrylate, ethyl acrylate, ethyl methacrylate, propyl acrylate, propyl methacrylate, n-, iso- and tert-butyl acrylate, n-, iso- and tert-butyl methacrylate, hexyl acrylate, hexyl methacrylate, ethylhexyl acrylate, stearyl acrylate and stearyl methacrylate. It is especially preferred to employ n-butyl acrylate or binary mixtures which contain between 10 and 90% by weight of n-butyl acrylate. It is very especially preferred to employ mixtures of n-butyl acrylate and tert-butyl acrylate.

To prepare the cationic aqueous polymer dispersion, the monomers of group c) which are employed are at least one nonionic, ethylenically unsaturated monomer other than a) and b). It is preferred to employ nitriles such as, for example, acrylonitrile or methacrylonitrile, amides such as, for example, acrylamide, methacrylamide or N-methylolacrylamide, vinyl compounds such as, for example, vinyl acetate or vinyl propionate, dienes such as, for example, butadiene or isoprene, and esters of acrylic acid or methacrylic acid and at least one ethylene oxide unit such as, for example, hydroxyethyl methacrylate or diethylene glycol monomethacrylate.

The concentration of the cationic aqueous polymer dispersion is preferably from 10 to 40% by weight, especially preferably from 15 to 35% by weight. The viscosity of a 20% dispersion is, as a rule, from 3 to 30 mPas, measured at a temperature of 23° C. The mean particle size of a 20% dispersion is preferably <100 nm; it is especially preferably from 5 to 50 nm. The mean particle size can be determined by methods known to the skilled worker such as, for example, laser correlation spectroscopy, ultracentrifugation or turbidimetry.

A particularly preferred embodiment of the invention is the use of aqueous polymer dispersions obtainable by polymerization of a monomer mixture in the presence of a hydrocolloid as graft base.

Hydrocolloids are macromolecular, hydrophilic substances which are soluble or dispersible in water and swellable, giving rise to viscous solutions, gels or stabilized systems, such as, for example, agar, carrageenan, xanthan, gellan, galactomannans, gum arabic, tragacanth, karaya, curdlan, beta-glucan, alginates, mannans, chitosan, celluloses, proteins, gelatin, pectins, starch, and their modified and/or degraded (for example hydrolyzed and/or oxidized) forms, and synthetic water-soluble polymers. The preferred hydrocolloid is degraded starch.

Such grafted aqueous polymer dispersions can be obtained for example by radical-initiated emulsion copolymerization of ethylenically unsaturated monomers in the presence of starch, characterized in that the ethylenically unsaturated monomers employed are

(a) 30 to 60% by weight of at least one optionally substituted styrene,
(b) 60 to 30% by weight of at least one C₁-C₄-alkyl (meth)acrylate,
(c) 0 to 10% by weight of other ethylenically unsaturated copolymerizable monomers,
the starch (d) employed is 10 to 40% by weight of degraded starch with a molar weight Mₙ=500 to 10 000, the total of (a)+(b)+(c)+(d) being 100%,
and the free-radical-initiator employed for the radical-initiated emulsion polymerization is a graft-active, water-soluble redox system.

Suitable monomers a) to c) are the compounds already disclosed for the cationic polymer dispersion.

The grafted polymer dispersions have a particle size of below 100 nm, preferably 50 to 90 nm

The present invention also provides for the use of the aqueous polymer dispersions in pest control compositions. In this context, they are used as described in the present application and as substantiated by examples.

The compositions used according to the invention comprise nonionic and/or ionic dispersants.

Examples of suitable nonionic surfactants are polyethylene oxide/polypropylene oxide block copolymers, polyethylene glycol ethers of linear alcohols, reaction products of fatty acids with ethylene oxide and/or propylene oxide, also polyvinyl alcohol, polyvinylpyrrolidone, mixed polymers of polyvinyl alcohol and polyvinylpyrrolidone, and copolymers of (meth)acrylic acid and (meth)acrylic esters, also alkyl ethoxylates and alkylaryl ethoxylates which may optionally be phosphated and may optionally be neutralized with bases, examples which may be mentioned being sorbitol ethoxylates.

Ionic dispersants which are preferably employed are anionic dispersants, for example modified sodium lignosulphonates, kraft sodium lignosulphonates, naphthalene-formaldehyde condensates, polyaspartic acid, polyacrylates, polyethylene sulphonates, modified starch, gelatin, gelatin derivatives or anionic surfactants (such as, for example, aromatic or aliphatic sulphates and sulphonates, or sulphated or sulphonated aromatic or aliphatic ethoxylates).

In the case of finely divided active ingredient particles, or active-ingredient-containing carrier particles, it is particularly preferred to use anionic and/or nonionic dispersants.

Besides the abovementioned components, the compositions used according to the invention optionally comprise
a thickener (optionally including thickening activator),
a preservative,
an antifoam,
one or more acids or bases in such an amount as to adjust the pH of the mixture in a targeted manner, or to activate thickener, and
further components for optimizing the performance properties of the formulation.

Suitable thickeners are all the substances which act as thickeners and which can conventionally be employed for this purpose in agrochemical compositions. Preferred substances are inorganic particles such as carbonates, silicates and oxides, and also organic substances such as urea/formaldehyde condensates. Examples which may be mentioned are kaolin, rutile, silicon dioxide, what is known as highly disperse silica, silica gels, and also natural and synthetic silicates, and also talc. Thickeners which can additionally be employed are synthetic thickeners such as polyacrylate thickeners (for example Carbopol® and Pemulen® thickeners from Lubrizol, Cleveland, USA), biological thickeners (for example Kelzan® S, xanthan gum, or further hydrocolloids from CP Kelco, Atlanta, USA) and inorganic thickeners (for example phyllosilicates such as kaolin, montmorillonite and Laponite®).

Preservatives which are suitable are all substances which can be employed for this purpose in agrochemical compositions of this type. Examples which may be mentioned are Preventol® (Lanxess AG) and Proxel® (Arch Chemical, Inc.).

Antifoams which are suitable are all substances which can be employed for this purpose in agrochemical compositions. Silicone oils and magnesium stearate are preferred.

The amount of active ingredient in the compositions used according to the invention can be varied within a wide range. In the case of concentrated formulations, for example aqueous suspension concentrates, it is generally between 0.01 and 40% by weight, preferably between 0.1 and 20% by weight, preferably between 1 and 20% by weight and especially preferably between 1 and 10% by weight.

The amount of polymer can also be varied within a wide range. In concentrated formulations, it is generally between 1 and 50% by weight, preferably between 2 and 40% by weight and especially preferably between 6 and 20% by weight. In this context, the amounts specified indicate the content based on the solids content. Frequently, it is in the form of an aqueous dispersion that the polymers are synthesized, or offered for sale, and employed for preparing the compositions used according to the invention.

The amount of active ingredient in ready-to-use compositions used according to the invention can be varied within a wide range. In the case of ready-to-use formulations, it is generally between 0.001 and 0.5% by weight, preferably between 0.01 and 0.1% by weight.

The amount of polymer in ready-to-use compositions used according to the invention can also be varied within a wide range. In ready-to-use formulations, it is generally between 0.002 and 1% by weight, preferably between 0.004 and 0.8% by weight and especially preferably between 0.01 and 0.4% by weight. In this context, the amounts specified indicate the content based on the solids content. Frequently, it is in the form of an aqueous dispersion that the polymers are offered for sale, and employed for preparing the compositions used according to the invention.

The compositions (suspension concentrates) used according to the invention are prepared in such a way that the components are mixed with one another in the ratios desired in each case. The sequence in which the components are mixed with one another is of no importance; however, it is usual to add the thickener last of all. The solid components are expediently employed in a finely-ground state. However, it is also possible to subject the suspension obtained after mixing the components first to coarse milling and then to fine milling, so that the average particle size is, for example, below 5 μm.

When carrying out the process, the temperatures can be varied within a certain range. Suitable temperatures are between 10° C. and 60° C., preferably between 15° C. and 40° C. Customary mixing and grinding equipment which is employed for the preparation of agrochemical formulations is suitable for carrying out the process.

It is also possible to use active ingredient particles, or active-ingredient-containing particles and/or granules, which have been obtained for example via spray drying, spray solidification or fluidized-bed processes (for example as described in EP 1 324 661). These are usually coarsely particulate, i.e. for example with an average particle size d50 greater than 5 μm (determined after dispersion in the water phase by means of laser diffraction).

The formulations used according to the invention can be used successfully for destroying harmful arthropods or nuisance arthropods, more particularly arachnids and insects.

These include pests from the following phylum:

Arthropoda, more particularly from the class of the Arachnida, e.g. Acarus spp., Aceria sheldoni, Aculops spp., Aculus spp., Amblyomma spp., Amphitetranychus viennensis, Argas spp., Boophilus spp., Brevipalpus spp., Bryobia praetiosa, Centruroides spp., Chorioptes spp., Dermanyssus gallinae, Dermatophagoides pteronyssius, Dermatophagoides farinae, Dermacentor spp., Eotetranychus spp., Epitrimerus pyri, Eutetranychus spp., Eriophyes spp., Halotydeus destructor, Hemitarsonemus spp., Hyalomma spp., Ixodes spp., Latrodectus spp., Loxosceles spp., Metatetranychus spp., Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vaejovis spp., Vasates lycopersici.

From the order of the Anoplura (Phthiraptera) e.g. Damalinia spp., Haematopinus spp., Linognathus spp., Pediculus spp., Ptirus pubis, Trichodectes spp.

From the order of the Chilopoda e.g. Geophilus spp., Scutigera spp.

From the order of the Coleoptera e.g. Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptorhynchus lapathi, Cylindrocopturus spp., Dermestes spp., Diabrotica spp., Dichocrocis spp., Diloboderus spp., Epilachna spp., Epitrix spp., Faustinus spp., Gibbium psylloides, Hellula undalis, Heteronychus arator, Heteronyx spp., Hylamorpha elegans, Hylotrupes bajulus, Hypera postica, Hypothenemus spp., Lachnosterna consanguinea, Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllotreta spp., Popillia japonica, Premnotrypes spp., Prostephanus truncatus, Psylliodes spp., Ptinus spp., Rhizobius ventralis, Rhizopertha dominica, Sitophilus spp., Sphenophorus spp., Stegobium paniceum, Sternechus spp., Symphyletes spp., Tanymecus spp., Tenebrio molitor, Tribolium spp., Trogoderma spp., Tychius spp., Xylotrechus spp., Zabrus spp.

From the order of the Collembola e.g. Onychiurus armatus.

From the order of the Diplopoda e.g. Blaniulus guttulatus.

From the order of the Diptera e.g. Aedes spp., Agromyza spp., Anastrepha spp., Anopheles spp., Asphondylia spp., Bactrocera spp., Bibio hortulanus, Calliphora erythrocephala, Ceratitis capitata, Chironomus spp., Chrysomyia spp., Chrysops spp., Cochliomyia spp., Contarinia spp., Cordylobia anthropophaga, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hylemyia spp., Hyppobosca spp., Hypoderma spp., Liriomyza spp., Lucilia spp., Lutzomia spp., Mansonia spp., Musca spp., Nezara spp., Oestrus spp., Oscinella frit, Pegomyia spp., Phlebotomus spp., Phorbia spp., Phormia spp., Prodiplosis spp., Psila rosae, Rhagoletis spp., Sarcophaga spp., Simulium spp, Stomoxys spp., Tabanus spp., Tannia spp., Tetanops spp., Tipula spp.

From the order of the Heteroptera e.g. Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.

From the order of the Homoptera e.g. Acyrthosipon spp., Acrogonia spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Drosicha spp., Dysaphis spp., Dysmicoccus spp., Empoasca spp., Eriosoma spp., Erythroneura spp., Euscelis bilobatus, Ferrisia spp., Geococcus coffeae, Hieroglyphus spp., Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes spp., Trioza spp., Typhlocyba spp., Unaspis spp., Viteus vitifolii, Zygina spp.

From the order of the Hymenoptera e.g. Acromyrmex spp., Athalia spp., Atta spp., Diprion spp., Hoplocampa spp., Lasius spp., Monomorium pharaonis, Solenopsis invicta, Tapinoma spp., Vespa spp.

From the order of the Isopoda e.g. Armadillidium vulgare, Oniscus asellus, Porcellio scaber.

From the order of the Isoptera e.g. Coptotermes spp., Cornitermes cumulans, Cryptotermes spp., Incisitermes spp., Microtermes obesi, Odontotermes spp., Reticulitermes spp.

From the order of the Lepidoptera e.g. Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., Choristoneura spp., Clysia ambiguella, Cnaphalocerus spp., Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamestra brassicae, Mocis spp., Mythimna separata, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudoplusia includens, Pyrausta nubilalis, Rachiplusia nu, Schoenobius spp., Scirpophaga spp., Scotia segetum, Sesamia spp., Sparganothis spp., Spodoptera spp., Stathmopoda spp., Stomopteryx subsecivella, Synanthedon spp., Tecia solanivora, Thermesia gemmatalis, Tinea pellionella, Tineola bisselliella, Tortrix spp., Trichophaga tapetzella, Trichoplusia spp., Tuta absoluta, Virachola spp.

From the order of the Orthoptera e.g. Acheta domesticus, Blatta orientalis, Blattella germanica, Dichroplus spp., Gryllotalpa spp., Leucophaea maderae, Locusta spp., Melanoplus spp., Periplaneta spp., Pulex irritans, Schistocerca gregaria, Supella longipalpa.

From the order of the Siphonaptera e.g. Ceratophyllus spp., Ctenocephalides spp., Tunga penetrans, Xenopsylla cheopis.

From the order of the Symphyla e.g. Scutigerella spp.

From the order of the Thysanoptera e.g. Anaphothrips obscurus, Baliothrips biformis, Drepanothris reuteri, Enneothrips flavens, Frankliniella spp., Heliothrips spp., Hercinothrips femoralis, Rhipiphorothrips cruentatus, Scirtothrips spp., Taeniothrips cardamoni, Thrips spp.

From the order of the Zygentoma (=Thysanura), e.g. Lepisma saccharina, Thermobia domestica.

Pests from the following phylum: Mollusca, more particularly from the class of the Bivalvia, e.g. Dreissena spp.

From the class of the Gastropoda e.g. Anion spp., Biomphalaria spp., Bulinus spp., Deroceras spp., Galba spp., Lymnaea spp., Oncomelania spp., Pomacea spp., Succinea spp.

Animal parasites from the following phylae: Plathelminthes and Nematoda, more particularly from the class of the Helminths e.g. Ancylostoma duodenale, Ancylostoma ceylanicum, Acylostoma braziliensis, Ancylostoma spp., Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp, Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

Plant pests from the following phylum: Nematoda, i.e. plant parasitic nematodes, more particularly Aphelenchoides spp., Bursaphelenchus spp., Ditylenchus spp., Globodera spp., Heterodera spp., Longidorus spp., Meloidogyne spp., Pratylenchus spp., Radopholus similis, Trichodorus spp., Tylenchulus semipenetrans, Xiphinema spp.

### Subphylum: Protozoa

It is additionally possible to control protozoa such as Eimeria.

Where the compositions used in accordance with the invention are not in a ready-to-use form (in the form for example of an aqueous suspension concentrate), they are initially diluted in water for the purpose of their intended use. Dilution in this case is carried out to an extent such that the active ingredient content ensures sufficient insecticidal or acaricidal activity at the intended application rate. This dilution produces compositions which correspond to the ready-to-apply compositions specified above.

These spray liquids are generally applied by spraying or misting. The application rate for the use of the suspension concentrates in accordance with the invention may be varied within a relatively wide range. It is guided by the particular active agrochemical ingredients and by the amount thereof in the formulations.

With the aid of the suspension concentrates used in accordance with the invention, active agrochemical ingredients can be delivered in a particularly advantageous way to plants and/or their habitats. The active agrochemical ingredients they comprise develop a better biological activity in this case (more particularly a better insecticidal or acaricidal availability and, in association therewith, an improved long-term activity in conjunction with good crop-plant tolerance) than when applied in the form of the corresponding conventional, prior-art formulations.

All plants and plant parts can be treated in accordance with the invention. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above the ground, such as shoot, leaf and flower, examples which may be mentioned being leaves, needles, stalks, stems, flowers, fruit bodies, fruits and seeds. The plant parts also include harvested material, and vegetative and generative propagation material, for example cuttings, tubers, rhizomes, offshoots and seeds.

Treatment according to the invention of the plants and plant parts with the suspension concentrates is carried out directly or by allowing the compositions to act on the surroundings, habitat or storage space by the customary treatment methods, for example by immersion, spraying, squirting, evaporation, misting, painting on, and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetically Modified Organisms), and parts thereof are treated. The terms “parts”, “parts of plants” and “plant parts” have been explained above.

Particularly preferably, plants of the plant cultivars which are in each case commercially available or in use are treated according to the invention. Plant cultivars are to be understood as meaning plants having novel properties (“traits”) which have been obtained by conventional breeding, by mutagenesis or by recombinant DNA techniques. These can be cultivars, biotypes and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

The transgenic plants or plant cultivars (obtained by genetic engineering) which are preferably to be treated according to the invention include all plants which, by virtue of the genetic modification, received genetic material which imparts particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defence of the plants against animal and microbial pests, such as against insects, mites, phytopathogenic fungi, bacteria and/or viruses, and also increased tolerance of the plants to certain herbicidally active ingredients. Examples of transgenic plants which may be mentioned are the important crop plants, such as cereals (wheat, rice), maize, soya beans, potatoes, cotton, oilseed rape, turnips, sugarcane and also fruit plants (with the fruits apples, pears, citrus fruits and grapes), and particular emphasis is given to maize, soya beans, potatoes, cotton, and oilseed rape. Traits that are emphasized in particular are the increased defence of the plants against insects by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to hereinbelow as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are furthermore particularly emphasized are the increased tolerance of the plants to certain herbicidally active ingredients, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya beans), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which plant cultivars will be developed and/or marketed in the future.

The plants listed can be treated in a particularly advantageous manner with the compositions (suspension concentrates) used according to the invention. The preferred ranges stated above for the suspension concentrates also apply to the treatment of these plants. Particular emphasis is given to the treatment of plants with the compositions (suspension concentrates) specifically mentioned in the present text.

The diluted spray solution can be sprayed in any customary manner, for example by squirting, pouring, spraying, injecting or brushing.

The active ingredient here is generally delivered at a concentration per unit area of 1 to 1000 g/ha, preferably at a concentration of 1 to 500 g/ha, more preferably at a concentration of 5 to 250 g/ha and very preferably at a concentration of 10 to 250 g/ha.

The compositions used in accordance with the invention are preferably applied to plants in a dilution and at an application rate such as to give an application of the polymer (based on solids) per unit area of 1.0 g/ha to 2000 g/ha, preferably of 5.0 g/ha to 500 g/ha, more preferably of 5 g/ha to 200 g/ha and very preferably of 10 g/ha to 200 g/ha.

The exact spectrum of action of the preparations used in accordance with the invention is of course dependent on the active ingredients employed.

### PREPARATION EXAMPLES

### Example 1

In a flask with stirrer, reflux condenser and jacket heating, 124.5 g of oxidatively degraded potato starch are dispersed under nitrogen in 985 g of deionized water and are dissolved by heating. In succession, 42.7 g of 1% strength iron(II) sulphate solution and 116 g of 3% strength hydrogen peroxide solution are added and the mixture is stirred for 15 min at 86° C. After 15 minutes, the two metering solutions below are metered in simultaneously but separately, with a constant metering rate over the course of 90 minutes at 86° C.:

1) 321 g of a mixture of styrene, n-butyl acrylate and tert-butyl acrylate
2) 93.7 g of 3% strength hydrogen peroxide solution.

After the end of the metering, stirring is continued at 86° C. for 15 minutes more and then 2 g of tert-butyl hydroperoxide are added for after-activation. After a further 60 minutes at 86° C., the temperature is reduced to room temperature, 10 g of a 10% solution of EDTA in the form of the tetrasodium salt are added and a pH of 6.5 is set using 13 g of 10% strength aqueous sodium hydroxide solution. The batch is filtered through a 100 μm filter cloth to give a finely-divided dispersion having a solids content of 24.0% by weight.

The proportion of styrene, n-butyl acrylate and tert-butyl acrylate can be varied in accordance with desired polymer properties (glass transition temperature, minimum film-formation temperature). The appropriate proportion can be determined experimentally in accordance with instructions above.

### BIOLOGICAL EXAMPLES

### Example No. 1

### Knockdown Activity

### Spodoptera exigua

The deltamethrin SC 62.5 composition used in accordance with the invention is prepared in the same way as in Example 1.

An appropriate application solution is prepared by mixing the desired proportion of formulated product with water to the desired concentration.

Bell pepper plants (Capsicum annuum) are sprayed with the application solution at the desired concentration and, after the coating has dried on, are populated with larvae of the beet armyworm (Spodoptera exigua).

After the desired time, the activity in % is determined. Here, 100% means that all of the caterpillars have been killed; 0% means that no caterpillars have been killed.

In this test, for example, the following formulation from the preparation examples showed superior activity as compared with the prior art:

TABLE 1
Spodoptera exigua on bell pepper

| | | Time for determi- | |
|---|---|---|---|
| | | nation of mor- | % Activity |
| | Concentration | tality/days after | (Abbott |
| Active ingredient (ai) | (g ai/ha) | infection | method) |
| Deltamethrin SC 62.5 | 15 | 1 | 90 |
| inventive | 7.5 | 1 | 80 |
| | 3.75 | 1 | 70 |
| Deltamethrin EC 100 | 15 | 1 | 70 |
| prior art | 7.5 | 1 | 50 |
| | 3.75 | 1 | 50 |

Deltamethrin EC 100 is a commercial emulsifiable concentrated deltamethrin with a concentration of 100 g/l, which does not include component c) (polymer dispersion) of the composition used in accordance with the invention (deltamethrin SC 62.5).

### Example No. 2

### Residual Activity

### Spodoptera exigua

An appropriate application solution is prepared by mixing the desired proportion of formulated product with water to the desired concentration.

Bell pepper plants (Capsicum annuum) are sprayed with the application solution at the desired concentration and, after certain intervals of time, are populated with larvae of the beet armyworm (Spodoptera exigua).

After the desired time, the activity in % is determined. Here, 100% means that all of the caterpillars have been killed; 0% means that no caterpillars have been killed.

In this test, for example, the following formulation from the preparation examples showed superior activity as compared with the prior art:

TABLE 2
Spodoptera exigua on bell pepper

| | | Time of | Time for determi- | |
|---|---|---|---|---|
| | | infection/days | nation of mor- | % Activity |
| | Concentration | after | tality/days after | (Abbott |
| Active ingredient (ai) | (g ai/ha) | application | infection | method) |
| Deltamethrin SC 62.5 | 15 | 14 | 1 | 100 |
| inventive | 7.5 | 14 | 1 | 100 |
| | 3.75 | 14 | 1 | 90 |
| Deltamethrin EC 100 | 15 | 14 | 1 | 60 |
| prior art | 7.5 | 14 | 1 | 40 |
| | 3.75 | 14 | 1 | 20 |

### Example No. 3

### Rain Resistance

### Spodoptera exigua

An appropriate application solution is prepared by mixing the desired proportion of formulated product with water to the desired concentration.

Bell pepper plants (Capsicum annuum) are sprayed with the application solution at the desired concentration and, after the coating has dried on, are irrigated with various amounts of water.

After the plants have dried off, the leaves are populated with larvae of the beet armyworm (Spodoptera exigua).

After the desired time, the activity in % is determined. Here, 100% means that all of the caterpillars have been killed; 0% means that no caterpillars have been killed.

In this test, for example, the following formulation from the preparation examples showed superior activity as compared with the prior art:

TABLE 3
Spodoptera exigua on bell pepper

| | | | Time for determi- | |
|---|---|---|---|---|
| | | | nation of mor- | % Activity |
| | Concentration | | tality/days after | (Abbott |
| Active ingredient (ai) | (g ai/ha) | Irrigation rate (l/h) | infection | method) |
| Deltamethrin SC 62.5 | 3.75 | 15 | 2 | 70 |
| inventive | | | | |
| Deltamethrin EC 100 | 3.75 | 15 | 2 | 50 |
| prior art | | | | |

### Example No. 4

### Knockdown Effect

### Spodoptera frugiperda

An appropriate application solution is prepared by mixing the desired proportion of formulated product with water to the desired concentration.

Maize plants (Zea maidis) are sprayed with the application solution at the desired concentration and, after the coating has dried on, are populated with armyworm (Spodoptera frugiperda).

After the desired time, the activity in % is determined. Here, 100% means that all of the caterpillars have been killed; 0% means that no caterpillars have been killed.

In this test, for example, the following formulation from the preparation examples showed superior activity as compared with the prior art:

TABLE 4
Spodoptera frugiperda on maize

| | | Time for determi- | |
|---|---|---|---|
| | | nation of mor- | % Activity |
| | Concentration | tality/days after | (Abbott |
| Active ingredient (ai) | (g ai/ha) | infection | method) |
| Deltamethrin SC 62.5 | 15 | 2 | 100 |
| inventive | 7.5 | 2 | 100 |
| | 3.75 | 2 | 50 |
| Deltamethrin EC 100 | 15 | 2 | 80 |
| prior art | 7.5 | 2 | 60 |
| | 3.75 | 2 | 10 |

### Example No. 5

### Residual Activity

### Spodoptera frugiperda

An appropriate application solution is prepared by mixing the desired proportion of formulated product with water to the desired concentration.

Maize plants (Zea maidis) are sprayed with the application solution at the desired concentration and, after certain intervals of time, are populated with the armyworm (Spodoptera frugiperda).

After the desired time, the activity in % is determined. Here, 100% means that all of the caterpillars have been killed; 0% means that no caterpillars have been killed.

In this test, for example, the following formulation from the preparation examples showed superior activity as compared with the prior art:

TABLE 5
Spodoptera frugiperda on maize

| | | Time of | Time for determi- | |
|---|---|---|---|---|
| | | infection/days | nation of mor- | % Activity |
| | Concentration | after | tality/days after | (Abbott |
| Active ingredient (ai) | (g ai/ha) | application | infection | method) |
| Deltamethrin SC 62.5 | 15 | 7 | 3 | 90 |
| inventive | 7.5 | 7 | 3 | 90 |
| | 3.75 | 7 | 3 | 80 |
| Deltamethrin EC 100 | 15 | 7 | 3 | 80 |
| prior art | 7.5 | 7 | 3 | 80 |
| | 3.75 | 7 | 3 | 40 |

1. Use of a composition comprising
at least one insecticide or acaricide
at least one nonionic and/or one ionic dispersant
an aqueous polymer dispersion
for improving the availability of the insecticide or acaricide on plant surfaces.

2. Use according to claim 1, where an aqueous polymer dispersion is used which is prepared by polymerization in the presence of a hydrocolloid as graft base.

3. Use according to claim 1, where an aqueous cationic polymer dispersion is used which comprises an emulsifier, which as a structural component has at least one (meth)acrylic ester and/or (meth)acrylamide, which contains a tertiary amino group.

4. Use according to claim 1, where an aqueous polymer dispersion is used which is obtainable by polymerization of a monomer mixture comprising one or more compounds selected from styrene, substituted styrene, acrylonitrile, methacrylonitrile, acrylic esters and (meth)acrylamides.

5. Use according to claim 1, where the composition is applied to the leaf surface of plants.

6. Use according to claim 1, where the bioavailability of the insecticide or acaricide on the plant surface is improved.

7. Use according to claim 1, where the long-term activity of the insecticide or acaricide is improved.

8. Use according to claim 1, where the protection of the insecticide or acaricide on the plant surface from environmental effects is improved.

9. Use according to claim 1, where the rain resistance of the insecticide or acaricide on the plant surface is improved.

10. Use according to claim 1, where the protection of the insecticide or acaricide from UV radiation is improved.
